(19) United States
(12) Patent Application Publication
(10) Pub. No.: US 2026/0146192 A1
(43) Pub. Date: May 28, 2026

(54) HEAT TRANSFER COMPOSITIONS, SYSTEMS AND METHODS

(71) Applicant: Solstice Advanced Materials US, Inc., Morris Plains, NJ (US)

(72) Inventors: NITIN KARWA, Morris Plains, NJ (US); MARTIN BLUHM, Morris Plains, NJ (US); ANKIT SETHI, Morris Plains, NJ (US); CHRIS ROGER, Morris Plains, NJ (US); GREGORY LAURENCE SMITH, Morris Plains, NJ (US)

(21) Appl. No.: 19/393,732

(22) Filed: Nov. 19, 2025

Related U.S. Application Data
(60) Provisional application No. 63/725,429, filed on Nov. 26, 2024.

(51) Int. Cl. C09K 5/04

(52) U.S. Cl. CPC C09K 5/044; C09K 2205/126

(57) ABSTRACT

Heat transfer compositions, and systems and methods using the composition, comprising: (a) a refrigerant comprising at least about 30% by weight based on all refrigerant components of trans-1-chloro-3,3,3-trifluoropropene (HFCO-1233zd(E)); and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene, farnesene, α-terpinene and combinations of two or more of these.

### CROSS REFERENCE TO RELATED APPLICATIONS

This application claims the priority benefit of U.S. Provisional Application No. 63/725,429 filed Nov. 26, 2024, which is incorporated herein by reference in its entirety.

### FIELD OF THE INVENTION

The present invention relates to heat transfer compositions, heat transfer methods and heat transfer systems, including but not limited to methods and systems using oil-free compressors for heat transfer applications.

### BACKGROUND

Mechanical refrigeration systems, and related heat transfer devices and methods, such as heat pumps (including high temperature heat pumps), are well known in the art for industrial, commercial and domestic uses. Typically, such systems utilize a heat transfer cycle that utilizes a compressor that operates on a working fluid that includes a refrigerant.

In a typically cooling operation of such systems, a relatively high pressure, high temperature refrigerant exits a compressor, is directed to a condenser where the refrigerant vapor is condensed to a refrigerant liquid, which in turn is converted to a relatively low temperature, low pressure refrigerant liquid by passing through an expansion device. This relatively low temperature, low pressure refrigerant is then directed to an evaporator where it is exposed to a fluid or body to be cooled. In the evaporator, the relatively low temperature, low pressure refrigerant changes phase from liquid to vapor by absorbing heat from (i.e., cooling) the body or fluid to be cooled. The low-pressure refrigerant vapor that exits from the evaporator is directed to the suction side of the compressor so that the heat transfer cycle can be repeated.

In a typical heating application, a relatively high pressure, high temperature refrigerant exits a compressor and is directed to a condenser where the hot refrigerant vapor is thermally exposed to a relatively cool fluid or body to be heated. The refrigerant vapor that enters the condenser is condensed to a refrigerant liquid, which in turn is converted to a relatively low temperature, low pressure refrigerant liquid by passing through an expansion device. This relatively low temperature, low pressure refrigerant is then directed to an evaporator where it absorbs heat from a fluid or body at a higher temperature (such as, for example, waste heat that might be available from an industrial process). In the evaporator, the relatively low temperature, low pressure refrigerant changes phase from liquid to vapor by absorbing heat from the heat source. The low-pressure refrigerant vapor that exits from the evaporator is directed to the suction side of the compressor so that the heat transfer cycle can be repeated.

In many of such heat transfer systems, devices and methods, the working fluid includes, in addition to the refrigerant, a lubricant for the compressor. In such an arrangement, as disclosed in U.S. Pat. No. 10,669,465, internal lubrication of the compressors is essential to reduce wear and heating of the moving members, to improve leak resistance and to protect against corrosion. The '465 patent relates to heat transfer compositions comprising a lubricant, a refrigerant comprising 1-chloro-3,3,3-trifluoropropene (HCFO-1233zd) and a stabilizer compound that is said to limit or to prevent an increase in the proportion of HCFO-1233zdZ present in the composition. The preferred stabilizing compound is said to be a C3 to C6 alkene stabilizing compound comprising a single double bond, such as the exemplified 2-methylbut-2-ene.

U.S. Pat. No. 9,523,026 also discloses stabilizers for hydrochlorofluoroolefin compounds, including 1233zd compounds, including when such compounds are used as refrigerants in heat transfer compositions. The '026 patent discloses that in such heat transfer uses the composition will typically also include lubricants suitable for use with refrigeration, air-conditioning, or heat pump apparatus. The stabilizer to be used is identified as being selected from free radical scavengers, acid scavengers, oxygen scavengers, polymerization inhibitors, corrosion inhibitors and combinations thereof. Exemplary stabilizers are identified as: 1,2-epoxybutane; glycidyl methyl ether; d,l-limonene; d,l-limonene oxide; 1,2-epoxy-2-methylpropane; nitromethane; diethylhydroxylamine; alpha-methylstyrene; isoprene; p-methoxyphenol; 3-methoxyphenol; hydrazines; 2,6-di-t-butylphenol and hydroquinone.

U.S. Pat. No. 10,215,455 discloses heat transmission methods for high-temperature heat pumps comprising one or more halogenated olefin compounds as the refrigerant, including a combination of cis-1,3,3,3-tetrafluoropropen, trans-1-chloro-3,3,3-trifluoropropene or 1,1,1,3,3-pentafluoropropane in an amount of 0.1% by mass or more and 20.0% by mass or less. While the '455 patent indicates that a large number of stabilizers may be included in such heat transfer compositions, it states that HFCO-1233zd(E) as a heat transfer medium shows high thermal stability, with no thermal decomposition and only a small amount of conversion of the trans isomer to the cis isomer during testing.

Applicants have discovered a problem with prior compositions, systems and methods, and have thus come to appreciate that despite contrary teachings in the prior art, a need exists for heat transfer compositions comprising HFCO-1233zd(E) but which have an improved ability to resist isomerization to the cis isomer, especially when used in high temperature applications (such as high temperature heat pumps) and/or when used in the substantial absence of lubricating oil, such as would be the case with systems that use oil-free compressors, and/or when used after relatively long periods.

### SUMMARY

The present invention provides improved heat transfer compositions comprising:
(a) a refrigerant comprising at least about 50% by weight based on all refrigerant components of trans-1-chloro-3,3,3-trifluoropropene (HFCO-1233zd(E)); and
(b) at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene, farnesene, α-terpinene and combinations of two or more of these, wherein said at least one compound is present in an amount of from 0.25% to about 2% by weight based on the weight of said HFCO-1233zd(E) and said at least one compound.

Heat transfer compositions according to this paragraph are sometimes referred to herein for convenience as Heat Transfer Composition 1A.

The present invention provides improved heat transfer compositions comprising:
(a) a refrigerant comprising at least about 50% by weight based on all refrigerant components of trans-1-chloro-3,3,3-trifluoropropene (HFCO-1233zd(E)); and
(b) d-limonene present in an amount of greater than 0.25% to about 2% by weight based on the weight of said HFCO-1233zd(E) and said d-limonene.

Heat transfer compositions according to this paragraph are sometimes referred to herein for convenience as Heat Transfer Composition 1B.

The present invention provides improved heat transfer compositions comprising:
(a) a refrigerant comprising at least about 50% by weight based on all refrigerant components of trans-1-chloro-3,3,3-trifluoropropene (HFCO-1233zd(E)); and
(b) 2,6-diisopropyl naphthalene present in an amount of greater than 0.25% to about 2% by weight based on the weight of said HFCO-1233zd(E) and said 2,6-diisopropyl naphthalene.

Heat transfer compositions according to this paragraph are sometimes referred to herein for convenience as Heat Transfer Composition 1C.

The present invention provides improved heat transfer compositions comprising:
(a) a refrigerant comprising at least about 50% by weight based on all refrigerant components of trans-1-chloro-3,3,3-trifluoropropene (HFCO-1233zd(E)); and
(b) β-pinene present in an amount of greater than 0.25% to about 2% by weight based on the weight of said HFCO-1233zd(E) and said β-pinene.

Heat transfer compositions according to this paragraph are sometimes referred to herein for convenience as Heat Transfer Composition 1D.

The present invention provides improved heat transfer compositions comprising:
(a) a refrigerant comprising at least about 50% by weight based on all refrigerant components of trans-1-chloro-3,3,3-trifluoropropene (HFCO-1233zd(E)); and
(b) farnesene present in an amount of greater than 0.25% to about 2% by weight based on the weight of said HFCO-1233zd(E) and said farnesene.

Heat transfer compositions according to this paragraph are sometimes referred to herein for convenience as Heat Transfer Composition 1E.

The present invention provides improved heat transfer compositions comprising:
(a) a refrigerant comprising at least about 50% by weight based on all refrigerant components of trans-1-chloro-3,3,3-trifluoropropene (HFCO-1233zd(E)); and
(b) α-terpinene present in an amount of greater than 0.25% to about 2% by weight based on the weight of said HFCO-1233zd(E) and said α-terpinene.

Heat transfer compositions according to this paragraph are sometimes referred to herein for convenience as Heat Transfer Composition 1F.

The present invention provides improved heat transfer compositions which are free of lubricating oil, and which comprise:
(a) a refrigerant comprising at least about 50% by weight based on all refrigerant components of trans-1-chloro-3,3,3-trifluoropropene (HFCO-1233zd(E)); and
(b) at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene, farnesene, α-terpinene and combinations of two or more of these, wherein said at least one compound is present in an amount of greater than 0.25% to about 2% by weight based on the weight of said HFCO-1233zd(E) and said at least one compound.

Heat transfer compositions according to this paragraph are sometimes referred to herein for convenience as Heat Transfer Composition 2A.

The present invention provides improved heat transfer compositions which are free of lubricating oil, and which comprise:
(a) a refrigerant comprising at least about 50% by weight based on all refrigerant components of trans-1-chloro-3,3,3-trifluoropropene (HFCO-1233zd(E)); and
(b) d-limonene present in an amount of greater than 0.25% to about 2% by weight based on the weight of said HFCO-1233zd(E) and said d-limonene.

Heat transfer compositions according to this paragraph are sometimes referred to herein for convenience as Heat Transfer Composition 2B.

The present invention provides improved heat transfer compositions which are free of lubricating oil, and which comprise:
(a) a refrigerant comprising at least about 50% by weight based on all refrigerant components of trans-1-chloro-3,3,3-trifluoropropene (HFCO-1233zd(E)); and
(b) 2,6-diisopropyl naphthalene present in an amount of greater than 0.25% to about 2% by weight based on the weight of said HFCO-1233zd(E) and said 2,6-diisopropyl naphthalene.

Heat transfer compositions according to this paragraph are sometimes referred to herein for convenience as Heat Transfer Composition 2C.

The present invention provides improved heat transfer compositions which are free of lubricating oil, and which comprise:
(a) a refrigerant comprising at least about 50% by weight based on all refrigerant components of trans-1-chloro-3,3,3-trifluoropropene (HFCO-1233zd(E)); and
(b) β-pinene present in an amount of greater than 0.25% to about 2% by weight based on the weight of said HFCO-1233zd(E) and said β-pinene.

Heat transfer compositions according to this paragraph are sometimes referred to herein for convenience as Heat Transfer Composition 2D.

The present invention provides improved heat transfer compositions which are free of lubricating oil, and which comprise:
(a) a refrigerant comprising at least about 50% by weight based on all refrigerant components of trans-1-chloro-3,3,3-trifluoropropene (HFCO-1233zd(E)); and
(b) farnesene present in an amount of greater than 0.25% to about 2% by weight based on the weight of said HFCO-1233zd(E) and said farnesene.

Heat transfer compositions according to this paragraph are sometimes referred to herein for convenience as Heat Transfer Composition 2E.

The present invention provides improved heat transfer compositions which are free of lubricating oil, and which comprise:
(c) a refrigerant comprising at least about 50% by weight based on all refrigerant components of trans-1-chloro-3,3,3-trifluoropropene (HFCO-1233zd(E)); and
(d) α-terpinene present in an amount of greater than 0.25% to about 2% by weight based on the weight of said HFCO-1233zd(E) and said α-terpinene.

Heat transfer compositions according to this paragraph are sometimes referred to herein for convenience as Heat Transfer Composition 2F.

The present invention provides improved heat transfer compositions which: (1) have been used in a plurality of heat transfer cycles which include a refrigerant temperature that includes at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene, farnesene, α-terpinene and combinations of two or more of these;
(b) wherein the amount in said refrigerant of said HFCO-1233zd(E), said HFCO-1233zd(Z) and said at least one compound, based on the total weight of those said components, is:
   a. at least 96% by weight of said HFCO-1233zd(E);
   b. not greater than 1% by weight of said HFCO-1233zd(Z); and
   c. from about 0.25% to about 2% by weight of said at least one compound.

Heat transfer compositions according to this paragraph are sometimes referred to herein for convenience as Heat Transfer Composition 3A.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene, farnesene, α-terpinene and combinations of two or more of these;
(b) wherein the amount in said refrigerant of said HFCO-1233zd(E), said HFCO-1233zd(Z) and said at least one compound, based on the total weight of those said components, is:
   a. at least 98% by weight of said HFCO-1233zd(E);
   b. not greater than 1% by weight of said HFCO-1233zd(Z); and
   c. from about 0.25% to about 1.5% by weight of said at least one compound.

Heat transfer compositions according to this paragraph are sometimes referred to herein for convenience as Heat Transfer Composition 3B.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene, farnesene, α-terpinene and combinations of two or more of these;
(b) wherein the amount in said refrigerant of said HFCO-1233zd(E), said HFCO-1233zd(Z) and said at least one compound, based on the total weight of those said components, is:
   a. at least 96% by weight of said HFCO-1233zd(E);
   b. not greater than 1% by weight of said HFCO-1233zd(Z); and
   c. from about 0.25% to about 1.0% by weight of said at least one compound.

Heat transfer compositions according to this paragraph are sometimes referred to herein for convenience as Heat Transfer Composition 3C.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene. farnesene, α-terpinene and combinations of two or more of these;
(b) wherein the amount in said refrigerant of said HFCO-1233zd(E), said HFCO-1233zd(Z) and said at least one compound, based on the total weight of those said components, is:
   a. at least 96% by weight of said HFCO-1233zd(E);
   b. not greater than 1% by weight of said HFCO-1233zd(Z); and
   c. from about 0.25% to about 0.6% by weight of said at least one compound.

Heat transfer compositions according to this paragraph are sometimes referred to herein for convenience as Heat Transfer Composition 3D.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound comprising d-limonene;
(b) wherein the amount in said refrigerant of said HFCO-1233zd(E), said HFCO-1233zd(Z) and said at least one compound, based on the total weight of those said components, is:
   a. at least 96% by weight of said HFCO-1233zd(E);
   b. not greater than 1% by weight of said HFCO-1233zd(Z); and
   c. from about 0.25% to about 0.6% by weight of said at least one compound.

Heat transfer compositions according to this paragraph are sometimes referred to herein for convenience as Heat Transfer Composition 3E.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound comprising β-pinene;
(b) wherein the amount in said refrigerant of said HFCO-1233zd(E), said HFCO-1233zd(Z) and said at least one compound, based on the total weight of those said components, is:
   i. at least 96% by weight of said HFCO-1233zd(E);
   ii. not greater than 1% by weight of said HFCO-1233zd(Z); and
   iii. from about 0.25% to about 0.6% by weight of said at least one compound.

Heat transfer compositions according to this paragraph are sometimes referred to herein for convenience as Heat Transfer Composition 3F.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound comprising 2,6-diisopropyl naphthalene;
(b) wherein the amount in said refrigerant of said HFCO-1233zd(E), said HFCO-1233zd(Z) and said at least one compound, based on the total weight of those said components, is:
   i. at least 96% by weight of said HFCO-1233zd(E);
   ii. not greater than 1% by weight of said HFCO-1233zd(Z); and
   iii. from about 0.25% to about 0.6% by weight of said at least one compound.

Heat transfer compositions according to this paragraph are sometimes referred to herein for convenience as Heat Transfer Composition 3G.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound comprising farnesene;
(b) wherein the amount in said refrigerant of said HFCO-1233zd(E), said HFCO-1233zd(Z) and said at least one compound, based on the total weight of those said components, is:
   i. at least 96% by weight of said HFCO-1233zd(E);
   ii. not greater than 1% by weight of said HFCO-1233zd(Z); and
   iii. from about 0.25% to about 0.6% by weight of said at least one compound.

Heat transfer compositions according to this paragraph are sometimes referred to herein for convenience as Heat Transfer Composition 3H.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound comprising α-terpinene;
(b) wherein the amount in said refrigerant of said HFCO-1233zd(E), said HFCO-1233zd(Z) and said at least one compound, based on the total weight of those said components, is:
   i. at least 96% by weight of said HFCO-1233zd(E);
   ii. not greater than 1% by weight of said HFCO-1233zd(Z); and
   iii. from about 0.25% to about 0.6% by weight of said at least one compound.

Heat transfer compositions according to this paragraph are sometimes referred to herein for convenience as Heat Transfer Composition 31.

The present invention provides improved heat transfer compositions which: (1) have been used in a plurality of heat transfer cycles which include a refrigerant temperature that includes at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)), at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound inhibiting isomerization being selected from the group consisting of d-limonene, 2,6-diisopropyl naphthalene, β-pinene, farnesene, α-terpinene and combinations of two or more of these;
(b) wherein the amount in said refrigerant of said HFCO-1233zd(E), said HFCO-1233zd(Z), and said at least one compound inhibiting isomerization, based on the total weight of those said components, is:
   i. at least 96% by weight of said HFCO-1233zd(E);
   ii. not greater than 1% by weight of said HFCO-1233zd(Z); and
   iii. from about 0.3% to about 0.5% by weight of said and said at least one compound.

Heat transfer compositions according to this paragraph are sometimes referred to herein for convenience as Heat Transfer Composition 4A.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and d-limonene;
   i. wherein the amount in said refrigerant of said HFCO-1233zd(E), said HFCO-1233zd(Z) and said d-limonene, based on the total weight of those said components, is:
   ii. at least 96% by weight of said HFCO-1233zd(E);
   iii. not greater than 1% by weight of said HFCO-1233zd(Z); and
   iv. from about 0.3% to about 0.5% by weight of d-limonene.

Heat transfer compositions according to this paragraph are sometimes referred to herein for convenience as Heat Transfer Composition 4B.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and 2,6-diisopropyl naphthalene;
(b) wherein the amount in said refrigerant of said HFCO-1233zd(E), said HFCO-1233zd(Z) and said 2,6-diisopropyl naphthalene, based on the total weight of those said components, is:
   i. at least 96% by weight of said HFCO-1233zd(E);
   ii. not greater than 1% by weight of said HFCO-1233zd(Z); and
   iii. from about 0.3% to about 0.5% by weight of said 2,6-diisopropyl naphthalene.

Heat transfer compositions according to this paragraph are sometimes referred to herein for convenience as Heat Transfer Composition 4C.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and β-pinene; (b) wherein the amount in said refrigerant of said HFCO-1233zd(E), said HFCO-1233zd(Z) and β-pinene, based on the total weight of those said components, is:
   i. at least 96% by weight of said HFCO-1233zd(E);
   ii. not greater than 1% by weight of said HFCO-1233zd(Z); and
   iii. from about 0.3% to about 0.5% by weight of said β-pinene.

Heat transfer compositions according to this paragraph are sometimes referred to herein for convenience as Heat Transfer Composition 4D.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and farnesene; (b) wherein the amount in said refrigerant of said HFCO-1233zd(E), said HFCO-1233zd(Z) and farnesene, based on the total weight of those said components, is:
   i. at least 96% by weight of said HFCO-1233zd(E);
   ii. not greater than 1% by weight of said HFCO-1233zd(Z); and
   iii. from about 0.3% to about 0.5% by weight of said farnesene.

Heat transfer compositions according to this paragraph are sometimes referred to herein for convenience as Heat Transfer Composition 4E.

The present invention provides improved heat transfer compositions which: (1) have been used in a plurality of heat transfer cycles which include a refrigerant temperature of at least about 110° C.; (2) are substantially free of lubricating oil; and (3) comprise:
(a) a refrigerant comprising at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and α-terpinene;
(b) wherein the amount in said refrigerant of said HFCO-1233zd(E), said HFCO-1233zd(Z) and α-terpinene, based on the total weight of those said components, is:
   i. at least 96% by weight of said HFCO-1233zd(E);
   ii. not greater than 1% by weight of said HFCO-1233zd(Z); and
   iii. from about 0.3% to about 0.5% by weight of said α-terpinene.

Heat transfer compositions according to this paragraph are sometimes referred to herein for convenience as Heat Transfer Composition 4F.

The present invention provides improved vapor compression heat transfer systems comprising:
(a) an oil-less compressor,
(b) an evaporator,
(c) a condenser and
(d) a substantially oil-free heat transfer composition circulating in said system, wherein said heat transfer composition comprises a refrigerant and wherein during at least a portion of said circulation said refrigerant is at a temperature of at least about 110° C.; and
wherein said refrigerant comprises:
   a. at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene farnesene, α-terpinene and combinations of two or more of these;
   b. wherein the amount in said refrigerant of said HFCO-1233zd(E), said HFCO-1233zd(Z) and said at least one compound, based on the total weight of those said components, is:
   i. at least 94% by weight of said HFCO-1233zd(E);
   ii. not greater than 1% by weight of said HFCO-1233zd(Z); and
   iii. from about 0.25% to about 2% by weight of said at least one compound.

Methods according to this paragraph are sometimes referred to herein for convenience as Heat Transfer System 1A.

The present invention provides improved vapor compression heat transfer systems comprising:
(a) an oil-less compressor,
(b) an evaporator,
(c) a condenser and
(d) a substantially oil-free heat transfer composition circulating in said system, wherein said heat transfer composition comprises a refrigerant and wherein: (1) during at least a portion of said circulation said refrigerant is at a temperature of at least about 110° C.; and (2) said heat transfer composition has been in said system for at least about 1 year; and
wherein said refrigerant comprises:
   i. at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene farnesene, α-terpinene and combinations of two or more of these; and wherein the amount in said refrigerant of said HFCO-1233zd(E), said HFCO-1233zd(Z) and said at least one compound, based on the total weight of those said components, is:
   i. at least 94% by weight of said HFCO-1233zd(E);
   ii. not greater than 1% by weight of said HFCO-1233zd(Z); and
   iii. from about 0.25% to about 2% by weight of said at least one compound.

Methods according to this paragraph are sometimes referred to herein for convenience as Heat Transfer System 1B.

The present invention provides improved high temperature heat pump systems comprising:
(a) an oil-less compressor
(b) an evaporator,
(c) a condenser,
(d) a substantially oil-free heat transfer composition circulating in said system, and
(e) an expansion device
wherein said heat transfer composition comprises refrigerant and wherein during at least a portion of said circulation said refrigerant is at a temperature of from about 110° C. to about 150° C.; and
wherein said refrigerant comprises:
   a. at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene, farnesene, α-terpinene and combinations of two or more of these; and
   b. wherein the amount in said refrigerant of said HFCO-1233zd(E), said HFCO-1233zd(Z) and said at least one compound, based on the total weight of those said components, is:
      (i) at least 94% by weight of said HFCO-1233zd(E);
      (ii) not greater than 1% by weight of said HFCO-1233zd(Z); and
      (iii) from about 0.25% to about 2% by weight of said at least one compound.

Methods according to this paragraph are sometimes referred to herein for convenience as Heat Transfer Systems 2A.

The present invention provides improved Organic Rankine Cycle (“ORC”) systems comprising:
(a) an oil-less turbine,
(b) an evaporator,
(c) a condenser,
(d) pump, and
(e) a substantially oil-free heat transfer composition circulating in said system;
wherein said heat transfer composition comprises refrigerant and wherein during at least a portion of said circulation said refrigerant is at a temperature of from about 110° C. to about 150° C.; and
wherein said refrigerant comprises:
   a. at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene, farnesene, α-terpinene and combinations of two or more of these;
   b. wherein the amount in said refrigerant of said HFCO-1233zd(E), said HFCO-1233zd(Z) and said at least one compound, based on the total weight of those said components, is:
      (i) at least 94% by weight of said HFCO-1233zd(E);
      (ii) not greater than 1% by weight of said HFCO-1233zd(Z); and
      (iii) from about 0.25% to about 2% by weight of said at least one compound.

Methods according to this paragraph are sometimes referred to herein for convenience as Heat Transfer Systems 2B.

### DETAILED DESCRIPTION

### Brief Description of the Figures

FIG. 1 is a schematic representation of an exemplary heat transfer system that can use the present heat transfer compositions, and which can be used in the present systems and methods, including high temperature heat pump systems and methods.

FIG. 2 is a schematic representation of an exemplary ORC heat transfer system that can use the present heat transfer compositions and methods.

### DEFINITIONS

As used herein with respect to weight percentages, the term “about” with respect to an amount of an identified component means the amount of the identified component can vary by an amount of +/−10% relative. For clarity and by way of example, the term “about 1%” means 1%+/−0.1%, the term “about 10%” means 10%+/−1%, and so on. Unless otherwise indicated or understood from the context, reference to an amount by “percent” or “%” is a reference to percentage by weight.

For the purposes of this invention, the term “about” in relation to temperatures in degrees centigrade (° C.) means that the stated temperature can vary by an amount of +/−5° C. In preferred embodiments, temperature specified as being about is preferably +/−2° C., more preferably +/−1° C., and even more preferably +/−0.5° C. of the identified temperature.

The term “capacity” is the amount of cooling provided, in BTUs/hr., by the refrigerant in the refrigeration system. This is experimentally determined by multiplying the change in enthalpy in BTU/lb., of the refrigerant as it passes through the evaporator (in the case of cooling and ORC) or as it passes through the condenser (in the case of heating as occurs in heat pumps) by the mass flow rate of the refrigerant. The enthalpy can be determined from the measurement of the pressure and temperature of the refrigerant. The capacity of the refrigeration system relates to the ability to maintain an area to be cooled at a specific temperature. The capacity of a refrigerant represents the amount of cooling or heating that it provides and provides some measure of the capability of a compressor to pump quantities of heat for a given volumetric flow rate of refrigerant. In other words, given a specific compressor, a refrigerant with a higher capacity will deliver more cooling or heating power.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “discharge temperature” refers to the temperature of the refrigerant at the outlet of the compressor. The advantage of a low discharge temperature is that it permits the use of existing equipment without activation of the thermal protection aspects of the system which are preferably designed to protect compressor components and avoids the use of costly controls such as liquid injection to reduce discharge temperature.

The phrase “Global Warming Potential” (hereinafter “GWP”) was developed to allow comparisons of the global warming impact of different gases. Specifically, it is a measure of how much energy the emission of one ton of a gas will absorb over a given period of time, relative to the emission of one ton of carbon dioxide. The larger the GWP, the more that a given gas warms the Earth compared to CO2 over that time period. The time period usually used for GWP is 100 years. GWP provides a common measure, which allows analysts to add up emission estimates of different gases. See www.epa.gov.

The term “Occupational Exposure Limit (OEL)” is determined in accordance with ASHRAE Standard 34-2016 Designation and Safety Classification of Refrigerants.

As the term is used herein, “TAN value” refers to the total acid number as determined in accordance with ASHRAE Standard 97—“Sealed Glass Tube Method to Test the Chemical Stability of Materials for Use within Refrigerant Systems” to simulate long-term stability of the heat transfer compositions by accelerated aging.

As used herein, the term “refrigerant” is used broadly to encompass fluids that are involved in heat transfer, whether heating or cooling, or as working fluids in ORC systems.

1233zd means 1-chloro-3,3,3-trifluoropropene, without limitation as to isomeric form.

Trans1233zd and 1233zd(E) each means trans1-chloro-3,3,3-trifluoropropene.

Cis1233zd and 1233zd(Z) each means cis1-chloro-3,3,3-trifluoropropene.

Farnesene means the compound having the following structure:

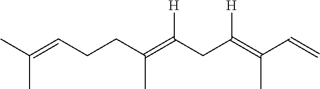

d-Limonene means the compound having the following structure:

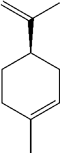

2,6-diisopropyl naphthalene means the compound having the following structure:

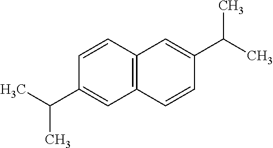 [SMILES: CC(C)c1ccc2cc(C(C)C)ccc2c1]

β-pinene means the compound having the following structure:

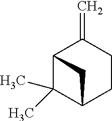

α-terpinene means the compound having the following structure:

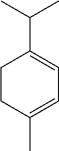

### Methods, Uses and Systems

The heat transfer compositions disclosed herein are provided for use and find advantage and produce unexpected results in essentially all heat transfer applications, uses, methods and systems, and all such applications, uses, methods and systems are included in the broad scope of the present invention. In preferred embodiments, the refrigerant compositions disclosed herein, including each of Heat Transfer Compositions 1-4, are provided for use with, and find advantage and produce unexpected results in, refrigeration applications in general. In particular preferred embodiments, the present methods and systems are high temperature heat pump systems or ORC systems and methods.

Particularly preferred embodiments are disclosed in the following Table 2, in which the following abbreviations are used and have the following meanings: “HTHP” means high temperature heat pump; “ORC” means organic Rankine Cycle; “GenRef” means refrigeration applications generally; “Oil-Free Comp” means the system uses a compressor that does not need or use lubricating oil in the heat transfer composition; and “Lub. Comp” means the system uses a compressor that does need the presence of lubricating oil in the heat transfer composition. The heat transfer compositions in column of Table 2 use “HTC” numbers as an abbreviation for the definitions of the Heat Transfer Composition numbers defined above. The presence of an “X” means the HTC in that row is used in combination with the system defined in that column, and the presence of a “-” means that the HTC in that row is not used in combination with the system defined in that column.

TABLE 2

| | USES/SYSTEMS/METHODS | | | | | | | |
|---|---|---|---|---|---|---|---|---|
| | HTHP | | ORC | | GenRef | | AC | |
| HTC | Oil-free | Lub. | Oil-free | Lub. | Oil-free | Lub. | Oil-free | Lub. |
| No. | Compressor | Comp | Turbine | Comp | Compressor | Comp | Compressor | Comp |
| 1A | x | x | x | x | x | x | x | x |
| 1B | x | x | x | x | x | x | x | x |
| 1C | x | x | x | x | x | x | x | x |
| 1D | x | x | x | x | x | x | x | x |
| 1E | x | x | x | x | x | x | x | x |
| 2A | x | — | x | — | x | — | x | — |
| 2B | x | — | x | — | x | — | x | — |
| 2C | x | — | x | — | x | — | x | — |
| 2D | x | — | x | — | x | — | x | — |
| 2E | x | — | x | — | x | — | x | — |
| 3A | x | — | x | — | x | — | x | — |
| 3B | x | — | x | — | x | — | x | — |
| 3C | x | — | x | — | x | — | x | — |
| 3D | x | — | x | — | x | — | x | — |
| 3E | x | — | x | — | x | — | x | — |
| 3F | x | — | x | — | x | — | x | — |
| 3G | x | — | x | — | x | — | x | — |
| 4A | x | — | x | — | x | — | x | — |
| 4B | x | — | x | — | x | — | x | — |
| 4C | x | — | x | — | x | — | x | — |
| 4E | x | — | x | — | x | — | x | — |
| 4F | x | — | x | — | x | — | x | — |
| 4G | x | — | x | — | x | — | x | — |
| 1A | x | x | x | x | x | x | x | x |
| 1B | x | x | x | x | x | x | x | x |
| 1C | x | x | x | x | x | x | x | x |
| 1D | x | x | x | x | x | x | x | x |
| 1E | x | x | x | x | x | x | x | x |
| 2A | x | — | x | — | x | — | x | — |
| 2B | x | — | x | — | x | — | x | — |
| 2C | x | — | x | — | x | — | x | — |
| 2D | x | — | x | — | x | — | x | — |
| 2E | x | — | x | — | x | — | x | — |
| 4H | x | — | x | — | x | — | x | — |
| 4H | x | — | — | — | x | x | x | x |

### Heat Pumps

A high temperature heat pump (sometimes referred to herein for convenience as “HTHP”) in its basic configuration comprises a fluid circuit which utilizes a circulating refrigerant to take-up or absorb heat from at least a first reservoir of heat (sometimes referred to herein as a “heat source”) at a relatively low temperature (sometimes referred to herein for convenience as a “low temperature heat source”) and then emitting or transmitting heat to at least a second reservoir which absorbs the heat (sometimes referred to herein as a heat sink) at a relatively high temperature (sometimes referred to herein for convenience as a “high temperature heat sink”). In preferred configurations the low temperature heat source is a plentiful source of heat at a relatively low temperature, such as might be available from low temperature industrial waste heat, geothermal energy from the ground and/or ground water, and the like, and the high temperature heat sink is a fluid which is desired to maintain in a relatively higher temperature range, such as hot water or steam or hot air.

The temperature of the low temperature heat source to be used in connection with the present refrigerants, systems and methods can vary widely, but in preferred embodiments will provide heat at temperatures of from about 5° C. to about 70° C., or from about 25° C. to about 60° C., or from about 25° C. to about 50° C., or from about 50° C. to about 70° C., or from about 40° C. to about 80° C., or from about 30° C. to about 80° C. Examples of low temperature heat sources useful in connection with the present invention include low grade industrial heat, air from the environment, water from the environment, brine, and in the case of geothermal energy, from the earth, including ground water.

With respect to the high temperature heat sinks which can absorb heat according to the present invention, the present invention is believed to be useful for a wide range of such heat sinks, including hot air, hot water (i.e., hot water at a temperature of at least about 90° C.), steam, and process streams in industrial processes of many types.

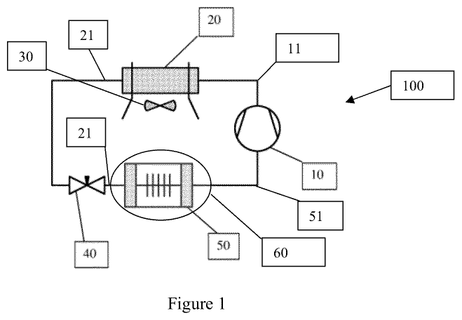

FIG. 1 is a generalized schematic view of a basic high-temperature heat pump device which contains and operates with the refrigerants of the present invention, including each of Heat Transfer Compositions 1 to 4.

FIG. 1 illustrates in block diagram form a HTHP 100 according to the present invention includes an evaporator 50 that receives heat from the low temperature heat source (represented schematically by the oval 60), including by undergoing a phase change from liquid to vapor as heat is absorbed from the low temperature heat source. It will be appreciated, however, that some level of sensible heat may also be transferred to the refrigerants of the present invention, including each of Heat Transfer Compositions 1-4, by the low temperature heat source. The vaporous refrigerant which exits evaporator 50 via line 51 is introduced to the suction side of compressor 10 which adds work to the refrigerant and increases both the temperature and the pressure of the refrigerant vapor. This high temperature vapor from the compressor 10 is transported via line 11 to the condenser 20 in which the refrigerant of the present invention, including each of Heat Transfer Compositions 1-4, supplies heat at a relatively high temperature to the high temperature heat sink, which is represented schematically (but not by way of limitation) by fan 30. The condensed refrigerant of the present invention is transported by line 21 to a pressure reducing device, such as an expansion valve, 40 where the pressure of the liquid refrigerant is reduced, thus producing relatively low temperature liquid refrigerant, which is then introduced via line 41 to the condenser, where the cycle begins again.

The specific type of equipment used in the present heat pump systems can vary widely within the scope of the present invention. For example, the compressor can be of centrifugal, screw and positive displacement type. However, in highly preferred environments the compressor is an oil-free compressor, and preferably oil-free piton compressors and oil-free centrifugal compressor and oil-free scroll compressors.

With respect to the heat exchangers 50 and 20, applicants note that the preferred refrigerants for use with the present heat transfer compositions, including each of Heat Transfer Compositions 1-4, can be azeotropic, azeotropic like, or zeotropic refrigerants having non-zero condenser glides and evaporator glides, for example of about 2° C. to less than about 15° C. In the case of the refrigerants which are zeotropic blends with glides in about this range, it is preferred that counter-current and/or cross current flow heat exchangers are used for evaporator(s) and the condenser(s), and in such cases the use of heat exchangers that do not permit fractionation during evaporation or condensation are preferred, and accordingly flooded heat exchangers are preferably not used on the refrigerant side and instead heat exchangers such as brazed plate heat exchangers, and similar heat exchangers which do not permit fractionation of refrigerant, are preferred. Thus, depending on the particular refrigerant used in each of Heat Transfer Compositions 1-4, the heat exchangers 20 and 50 of the present systems and methods can be flooded heat evaporators/condensers or dry expansion or direct expansion type (and not a flooded type).

The type of expansion device used can vary. The expansion device can be an expansion valve, which can be electronic or thermostatic as needed by the specifics of the design. This description does not limit any possible additional variances for the specific equipment or the use of additional components that are not illustrated in FIG. 1, such as suction line heat exchangers, vapor ejectors and the like.

The following Table 1 identifies preferred high temperature heat pump methods of the present invention (identified by the HTHP Method numbers in column 1) using the heat transfer compositions of the present invention (identified in column 2 by numbers corresponding to the Heat Transfer Compositions Numbers defined above and abbreviated in the following table as “HTC No.”), using a direct expansion evaporator and having the operating parameters as specified in the table.

### High Temperature Heat Pump Method Conditions

| HTHP | | | LTHS | | HTHS. |
|---|---|---|---|---|---|
| Method | HTC | Low Temp. Heat | Temp., | High Temp. | Temp., |
| No. | No. | Source | ° C. | Heat Sink | ° C. |
| 1A | 1A | Industrial waste | 30-90 | Industrial | 110-145 |
| | | heat | | Steam | |
| 1B | 1A | Industrial waste | 30-90 | Low Pressure | 115-130 |
| | | heat | | Steam | |
| 1C | 1A | Industrial waste | 30-90 | Hot water | =>90 |
| | | heat | | | |
| 2A | 1B | Industrial waste | 30-90 | Industrial | 110-145 |
| | | heat | | Steam | |
| 2B | 1B | Industrial waste | 30-90 | Low Pressure | 115-130 |
| | | heat | | Steam | |
| 2C | 1B | Industrial waste | 30-90 | Hot water | 50-70 |
| | | heat | | | |
| 3A | 1C | Industrial waste | 30-90 | Industrial | 110-145 |
| | | heat | | Steam | |
| 3B | 1C | Industrial waste | 30-90 | Low Pressure | 115-130 |
| | | heat | | Steam | |
| 3C | 1C | Industrial waste | 30-90 | Hot water | =>90 |
| | | heat | | | |
| 4A | 1D | Industrial waste | 30-90 | Industrial | 110-145 |
| | | heat | | Steam | |
| 4B | 1D | Industrial waste | 30-90 | Low Pressure | 115-130 |
| | | heat | | Steam | |
| 4C | 1D | Industrial waste | 30-90 | Hot water | =>90 |
| | | heat | | | |
| 5A | 2A | Industrial waste | 30-90 | Industrial | 110-145 |
| | | heat | | Steam | |
| 5B | 2A | Industrial waste | 30-90 | Low Pressure | 115-130 |
| | | heat | | Steam | |
| 5C | 2A | Industrial waste | 30-90 | Hot water | =>90 |
| | | heat | | | |
| 6A | 2B | Industrial waste | 30-90 | Industrial | 110-145 |
| | | heat | | Steam | |
| 6B | 2B | Industrial waste | 30-90 | Low Pressure | 115-130 |
| | | heat | | Steam | |
| 6C | 2B | Industrial waste | 30-90 | Hot water | =>90 |
| | | heat | | | |
| 7A | 2C | Industrial waste | 30-90 | Industrial | 110-145 |
| | | heat | | Steam | |
| 7B | 2C | Industrial waste | 30-90 | Low Pressure | 115-130 |
| | | heat | | Steam | |
| 7C | 20 | Industrial waste | 30-90 | Hot water | =>90 |
| | | heat | | | |
| 8A | 2D | Industrial waste | 30-90 | Industrial | 110-145 |
| | | heat | | Steam | |
| 8B | 2D | Industrial waste | 30-90 | Low Pressure | 115-130 |
| | | heat | | Steam | |
| 8C | 2D | Industrial waste | 30-90 | Hot water | =>90 |
| | | heat | | | |
| 9A | 2E | Industrial waste | 30-90 | Industrial | 110-145 |
| | | heat | | Steam | |
| 9B | 2E | Industrial waste | 30-90 | Low Pressure | 115-130 |
| | | heat | | Steam | |
| 9C | 2E | Industrial waste | 30-90 | Hot water | =>90 |
| | | heat | | | |
| 10A | 3A | Industrial waste | 30-90 | Industrial | 110-145 |
| | | heat | | Steam | |
| 10B | 3A | Industrial waste | 30-90 | Low Pressure | 115-130 |
| | | heat | | Steam | |
| 10C | 3A | Industrial waste | 30-90 | Hot water | =>90 |
| | | heat | | | |
| 11A | 3B | Industrial waste | 30-90 | Industrial | 110-145 |
| | | heat | | Steam | |
| 11B | 3B | Industrial waste | 30-90 | Low Pressure | 115-130 |
| | | heat | | Steam | |
| 11C | 3B | Industrial waste | 30-90 | Hot water | =>90 |
| | | heat | | | |
| 12A | 3C | Industrial waste | 30-90 | Industrial | 110-145 |
| | | heat | | Steam | |
| 12B | 3C | Industrial waste | 30-90 | Low Pressure | 115-130 |
| | | heat | | Steam | |
| 12C | 3C | Industrial waste | 30-90 | Hot water | =>90 |
| | | heat | | | |
| 13A | 3D | Industrial waste | 30-90 | Industrial | 110-145 |
| | | heat | | Steam | |
| 13B | 3D | Industrial waste | 30-90 | Low Pressure | 115-130 |
| | | heat | | Steam | |
| 13C | 3D | Industrial waste | 30-90 | Hot water | =>90 |
| | | heat | | | |
| 14A | 3E | Industrial waste | 30-90 | Industrial | 110-145 |
| | | heat | | Steam | |
| 14B | 3E | Industrial waste | 30-90 | Low Pressure | 115-130 |
| | | heat | | Steam | |
| 14C | 3E | Industrial waste | 30-90 | Hot water | =>90 |
| | | heat | | | |
| 15A | 3F | Industrial waste | 30-90 | Industrial | 110-145 |
| | | heat | | Steam | |
| 15B | 3F | Industrial waste | 30-90 | Low Pressure | 115-130 |
| | | heat | | Steam | |
| 15C | 3F | Industrial waste | 30-90 | Hot water | =>90 |
| | | heat | | | |
| 16A | 3G | Industrial waste | 30-90 | Industrial | 110-145 |
| | | heat | | Steam | |
| 16B | 3G | Industrial waste | 30-90 | Low Pressure | 115-130 |
| | | heat | | Steam | |
| 16C | 3G | Industrial waste | 30-90 | Hot water | =>90 |
| | | heat | | | |
| 17A | 4A | Industrial waste | 30-90 | Industrial | 110-145 |
| | | heat | | Steam | |
| 17B | 4A | Industrial waste | 30-90 | Low Pressure | 115-130 |
| | | heat | | Steam | |
| 17C | 4A | Industrial waste | 30-90 | Hot water | =>90 |
| | | heat | | | |
| 18A | 4B | Industrial waste | 30-90 | Industrial | 110-145 |
| | | heat | | Steam | |
| 18B | 4B | Industrial waste | 30-90 | Low Pressure | 115-130 |
| | | heat | | Steam | |
| 18C | 4B | Industrial waste | 30-90 | Hot water | =>90 |
| | | heat | | | |
| 19A | 4C | Industrial waste | 30-90 | Industrial | 110-145 |
| | | heat | | Steam | |
| 19B | 4C | Industrial waste | 30-90 | Low Pressure | 115-130 |
| | | heat | | Steam | |
| 19C | 4C | Industrial waste | 30-90 | Hot water | =>90 |
| | | heat | | | |
| 20A | 4D | Industrial waste | 30-90 | Industrial | 110-145 |
| | | heat | | Steam | |
| 20B | 4D | Industrial waste | 30-90 | Low Pressure | 115-130 |
| | | heat | | Steam | |
| 20C | 4D | Industrial waste | 30-90 | Hot water | =>90 |
| | | heat | | | |
| 21A | 4E | Industrial waste | 30-90 | Industrial | 110-145 |
| | | heat | | Steam | |
| 21B | 4E | Industrial waste | 30-90 | Low Pressure | 115-130 |
| | | heat | | Steam | |
| 21C | 4E | Industrial waste | 30-90 | Hot water | =>90 |
| | | heat | | | |
| 22A | 4F | Industrial waste | 30-90 | Industrial | 110-145 |
| | | heat | | Steam | |
| 22B | 4F | Industrial waste | 30-90 | Low Pressure | 115-130 |
| | | heat | | Steam | |
| 22C | 4F | Industrial waste | 30-90 | Hot water | =>90 |
| | | heat | | | |
| 23A | 4G | Industrial waste | 30-90 | Industrial | 110-145 |
| | | heat | | Steam | |
| 23B | 4G | Industrial waste | 30-90 | Low Pressure | 115-130 |
| | | heat | | Steam | |
| 23C | 4G | Industrial waste | 30-90 | Hot water | =>90 |
| | | heat | | | |
| 24A | 4H | Industrial waste | 30-90 | Industrial | 110-145 |
| | | heat | | Steam | |
| 24B | 4H | Industrial waste | 30-90 | Low Pressure | 115-130 |
| | | heat | | Steam | |
| 24C | 4H | Industrial waste | 30-90 | Hot water | =>90 |
| | | heat | | | |

### ORC Systems and Methods

An Organic Rankine cycle (sometimes referred to herein for convenience as “ORC”) in its basic configuration includes: (1) a condenser that transfers heat from a heat transfer composition of the present invention, including each of Heat Transfer Compositions 1-4, in a vapor state by condensing the vaporous refrigerant to a liquid refrigerant; and (2) an evaporator (boiler) that transfers heat from a heat source to the liquid heat transfer composition by evaporating the refrigerant liquid to produce a heat transfer composition vapor. Connected between the outlet of the condenser and the inlet to evaporator (boiler) is a liquid pump which raises the pressure of the heat transfer composition to above about the operating pressure of the evaporator. Connected between the outlet of the evaporator (boiler) and the inlet to the condenser is an expander that uses a pressure drop of the heat transfer composition to produce useful mechanical energy (e.g., turbine). In this way a circuit is created which produces useful mechanical energy from the cycle through which the heat transfer composition passes.

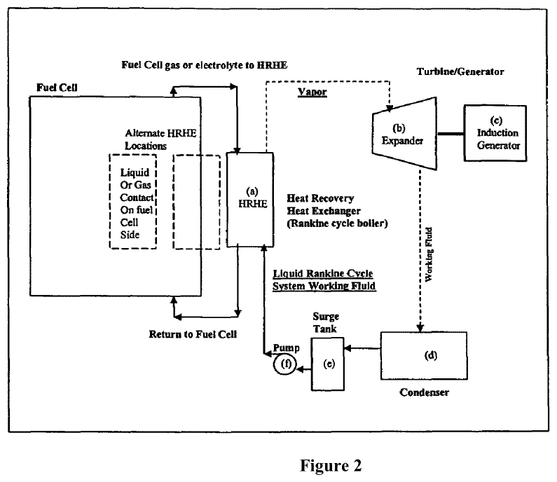

A non-limiting example of an ORC system is illustrated in FIG. 2. In FIG. 2, an organic Rankine cycle is illustrated which is configured to utilize waste heat from fuel cells. It will be appreciated, however, that any heat source with the appropriate amount and temperature of heat could be used in an ORC, including the ORC illustrated in FIG. 2. In the illustrated embodiment, the evaporator/boiler is labeled as a heat recovery heat exchanger (a) which transfers heat generated within the fuel cell to the Rankine cycle system working fluid, which is a heat transfer composition of the present invention, including each of Heat Transfer Compositions 1-4. The heat exchanger/boiler can be located internal or external to the fuel cell. When the heat recovery heat exchanger/boiler is located outside the fuel cell (as shown), in its simplest form, a tube or tubes could be used to convey hot gas or liquid electrolyte from the fuel cell to the external heat recovery heat exchanger (Rankine cycle system boiler) and then return the cooler fuel cell fluid to the fuel cell. In an alternative arrangement, the heat exchanger is located in contact with the heat source (such as being inside the fuel cell), in which case the relatively cool heat transfer composition of the present invention, including each of Heat Transfer Compositions 1-4, is circulated into and out of the heat source by a tube or tubes. Of course, a combination of these two arrangements could be used, such as being located partially within and partially outside the fuel cell. Any appropriate heat exchanger design can be used, including fin/plate, shell/tube, fin/tube, microchannel, including double-wall or other designs.

The Rankine cycle system working fluid, i.e., the heat transfer composition of the present invention, including each of Heat Transfer Compositions 1-4, thus circulates through the heat recovery heat exchanger where it gains heat by evaporation. The working fluid vapor is routed to the expander/turbine (b) where the expansion process results in conversion of the heat energy into mechanical shaft power. The shaft power can be used to do any mechanical work by employing conventional arrangements of belts, pulleys, gears, transmissions or similar devices depending on the desired speed and torque required. Importantly, the shaft can be connected to an electric power-generating device (c) such as an induction generator. The electricity produced can be used locally or delivered to the grid. Working fluid that exits the expander/turbine continues to the condenser (d) where adequate heat rejection causes the fluid to condense to liquid. It is also desirable to have a liquid surge tank (e) located between the condenser and pump to ensure there is always an adequate supply of liquid heat transfer composition to the pump suction. The liquid flows to a pump (f) that elevates the pressure of the fluid so that it can be introduced back into the heat recovery heat exchanger thus completing the Rankine cycle loop.

While an organic Rankine cycle is repeated by use of the working fluid according to the present invention, thermal energy is converted into mechanical energy via the basic steps (a) through (f) illustrated in FIG. 2 and described above, and the mechanical energy is supplied to the power generator and is extracted preferably as electric energy.

Thus, in an ORC of the present invention, a fluid circuit which utilizes a circulating heat transfer composition of the present invention, including each of Heat Transfer Compositions 1-4, to take-up or absorb heat from at least a first reservoir of heat (sometimes referred to herein as the ORC “heat source”) at a relatively high temperature (also sometimes referred to herein for convenience as a “high temperature ORC heat source”) and then emitting or transmitting heat to at least a second reservoir which absorbs the heat (sometimes referred to herein as a ORC heat sink) at a relatively low temperature (sometimes referred to herein for convenience as a “low temperature ORC heat sink”). In preferred configurations the high temperature ORC heat source is a plentiful source of heat at a relatively high temperature, such as might be available from high temperature industrial waste heat (including fuel cell waste heat), geothermal energy from the ground and/or ground water, solar collectors and the like, and the low temperature ORC heat sink is a fluid which is desired to maintain in a relatively lower temperature range, such as cold water or steam or cold air.

The temperature of the low temperature ORC heat sink to be used in connection with the present refrigerants, systems and methods can vary widely, but in preferred embodiments will provide heat at temperatures of from about 5° C. to about 70° C., or from about 25° C. to about 60° C., or from about 25° C. to about 50° C., or from about 50° C. to about 70° C., or from about 40° C. to about 80° C., or from about 30° C. to about 80° C. Examples of low temperature heat sinks useful in connection with the present invention include air from the environment and water from the environment.

With respect to the high temperature heat source which can absorb heat according to the present invention, the present invention is believed to be useful for a wide range of such heat sinks, including hot air, hot water, and steam, preferably at temperatures above 90° C. and up to about 145° C.

### EXAMPLES

### Comparative Example 1A—Isomerization Stability of Refrigerant Composition Consisting of 1233zd(E)

A refrigerant composition was tested to provide a representation of relative long-term stability of the refrigerant under accelerated aging. The testing was conducted by placing the tested refrigerant composition in a stainless-steel Parr Cell and then heating the cell to the indicated temperature for the indicated period of time. In the case of this Comparative Example 1, the tested refrigerant consisted essentially of 100% trans1233zd (i.e., essentially 0% of cis1233zd and with no lubricant present) and the refrigerant was maintained at temperature of 200° C. for a period of 28 days. The refrigerant was tested at various intervals during this period and, most importantly, for use as a predictive measure of the long-term stability of the refrigerant under commercial conditions, at the end of the 28-day period. At the end of the 28-day period, the refrigerant in the Parr Cell was found to contain about 5.4% of cis1233zd.

### Comparative Example 1B-Isomerization Stability of Refrigerant Composition Consisting of 1233zd(E) and 2-Methyl-2-Butene

U.S. Pat. No. 10,618,861 discloses that a preferred compound to inhibit the isomerization of trans1233zd to cis1233zd is 2-methyl-2-butene. According to U.S. Pat. No. 10,618,861 after maintaining 100% R1233zd(E) with 0.5% of 2-methyl-2-butene at 200° C. for 24 hours, the content of the sealed tube was tested and found to have a concentration of 0.07 wt % of 1233zd(Z). Such a short duration of accelerated testing is not sufficient to determine the amount of R1233zd(Z) formation over a longer duration of operation. Comparative Example 1A was repeated except that the starting test refrigerant consists of essentially 100% trans1233zd (i.e., essentially 0% of cis1233zd and no lubricant) with 5 mmol (0.24 wt %) of 2-methyl-2-butene. After being maintained at 200° C. for 24 hours, the contents of the Parr Cell were tested and found to have a concentration of just under 0.04% of 1233zd(Z), which is comparable to the U.S. Pat. No. 10,618,861. But after being maintained at 200° C. for 7, 14 and 28 days, the contents of the Parr Cell were tested and found to have a concentration of 0.6%, 1.1% and just under 4% of 1233zd(Z), respectively. While this result indicates that this use of 2-methyl-2-butene produces a relatively small (about 20% relative) reduction in the concentration of cis1233zd produced during the test, it remains well above the target of not greater than 1% cis1233zd for this test. For many important applications, this would not be considered to be a commercially acceptable result.

### Example 1—Isomerization Stability of Refrigerant Composition Consisting of 1233zd(E) and d-Limonene

Comparative Example 1B was repeated except that instead of containing 5 mmol of 2-methyl-2-butene, the starting test refrigerant consists of essentially 100% trans1233zd (i.e., essentially 0% of cis1233zd and no lubricant) with 5 mmol (0.5 wt %) of d-limonene in accordance with an embodiment of the present invention. After being maintained at 200° C. for 24 hours, 7 day, 14 days, 21 days and 42 days, the contents of the Parr Cell were tested and found to have about 0.01%, 0.06%, 0.62%, 0.6%, and 0.65% by weight of cis1233zd, respectively. Thus, as shown by the results of this test, this embodiment of the present invention is able to inhibit isomerization of 1233zd(E) to 1233zd(Z) such that the concentration of the cis isomer was reduced to a value that was less than ⅛th of the Comparative Example 1 concentration and less than ⅙th of the value resulting from the use of 2-methyl-2-butene to inhibit isomerization. As shown by the results of this test, this embodiment of the present invention is able to inhibit isomerization of 1233zd(E) to 1233zd(Z) such that the concentration of the cis isomer was reduced to a value less than 0.65% by weight over duration from 14 days to 42 days. Comparative Example 1B was repeated except that instead of containing 5 mmol of 2-methyl-2-butene, the starting test refrigerant consists of essentially 100% trans1233zd (i.e., essentially 0% of cis1233zd and no lubricant) with 0.1 to 1% (0.5 wt %) of d-limonene in accordance with an embodiment of the present invention. After being maintained at 200° C. for 42 days, the contents of the Parr Cells with 0.1%, 0.3%, 0.5%, 1% were tested and found to have about 1.5%, 0.5%, 0.65% and 0.8% by weight of cis1233zd, respectively. This is a highly desirable but unexpected result.

### Comparative Example 2A—Refrigerant Consisting of 1233zd(E) in Sealed Glass Tubes in Presence of Metal Coupons

A refrigerant composition consisting of essentially 100 percent trans1233zd (i.e., essentially 0% of cis1233zd and no lubricant) was tested under the procedures in accordance with ASHRAE Standard 97—“Sealed Glass Tube Method to Test the Chemical Stability of Materials for Use within Refrigerant Systems” to simulate long-term stability of the refrigerant compositions by accelerated aging in the presence of Cu/Al/Fe coupons. Two test conditions were conducted: (1) 14 days at 150° C. and (2) 24 hours at 200° C. At the end of the respective test, the relative amounts of trans1233zd and cis1233zd present in the composition were as shown in Table CE2A below:

TABLE CE2A
Glass Tube with Coupons - Control

| | |
|---|---|
| Component | Amount (wt %) |

14 Day/150° C. Test Results

| | |
|---|---|
| 1233zd(E) | 99.7091 |
| 1233zd(Z) | 0.2909 |
| Total | 100.000 |

24 Hours/200° C. Test Results

| | |
|---|---|
| 1233zd(E) | 99.1612 |
| 1233zd(Z) | 0.8388 |
| Total | 100.0000 |

As can be seen from the results above in Table CE2A, substantial isomerization occurs during each of the test conditions.

### Examples 2A—2E Refrigerant Consisting of 1233zd and Each of d-Limonene, 2,6-Isopropyl Naphthalene, R-Pinene, Farnesene, and α-Terpinene in Sealed Glass Tubes in Presence of Metal Coupons

Comparative Example 2A is repeated, except that 5000 ppm of each of d-limonene, β-pinene, 2,6-isopropyl naphthalene, farnesene and α-terpinene was added to the starting refrigerant composition consisting of essentially 100% trans1233zd (i.e., essentially 0% of cis1233zd and no lubricant). The results of these tests are shown in Tables E2A-E below:

TABLE E2A
d-limonene

| | |
|---|---|
| Component | Amount (wt %) |

14 Day/150° C. Test Results

| | |
|---|---|
| 1233zd(E) | 99.9983 |
| 1233zd(Z) | 0.0017 |
| Total | 100.000 |

24 Hours/200° C. Test Results

| | |
|---|---|
| 1233zd(E) | 99.9937 |
| 1233zd(Z) | 0.0063 |
| Total | 100.0000 |

TABLE E2B
β-pinene

| | |
|---|---|
| Component | Amount (wt %) |

14 Day/150° C. Test Results

| | |
|---|---|
| 1233zd(E) | 99.9984 |
| 1233zd(Z) | 0.0016 |
| Total | 100.000 |

24 Hours/200° C. Test Results

| | |
|---|---|
| 1233zd(E) | 99.9934 |
| 1233zd(Z) | 0.0066 |
| Total | 100.0000 |

TABLE E2C
2,6-isopropyl naphthalene

| | |
|---|---|
| Component | Amount (wt %) |

14 Day/150° C. Test Results

| | |
|---|---|
| 1233zd(E) | 99.9971 |
| 1233zd(Z) | 0.0029 |
| Total | 100.000 |

24 Hours/200° C. Test Results

| | |
|---|---|
| 1233zd(E) | 99.9935 |
| 1233zd(Z) | 0.0065 |
| Total | 100.0000 |

TABLE E2D
Farnesene

| | |
|---|---|
| Component | Amount (wt %) |

14 Day/150° C. Test Results

| | |
|---|---|
| 1233zd(E) | 99.9959 |
| 1233zd(Z) | 0.0041 |
| Total | 100.000 |

24 Hours/200° C. Test Results

| | |
|---|---|
| 1233zd(E) | 99.9829 |
| 1233zd(Z) | 0.0171 |
| Total | 100.0000 |

TABLE E2E
α-terpinene

| | |
|---|---|
| Component | Amount (wt %) |

14 Day/150° C. Test Results

| | |
|---|---|
| 1233zd(E) | 99.9946 |
| 1233zd(Z) | 0.0054 |
| Total | 100.000 |

24 Hours/200° C. Test Results

| | |
|---|---|
| 1233zd(E) | 99.9849 |
| 1233zd(Z) | 0.0151 |
| Total | 100.0000 |

As can be seen from the results in the tables above, the compounds of the present invention provide a dramatic and unexpected improvement compared to the results from Comparative Example 2A.

As can be seen from the results of this example, a dramatic and unexpected improvement in both ageing tests is achieved by all of the compounds of the present invention. For example, for the 14-day exposure test using d-limonene, the concentration of cis1233zd in accordance with this example of the present invention is only 0.0016 weight percent (16 ppm), compared to about 0.2909 weight percent (2909 ppm) in the control. Thus, the concentration of 1233zd(Z) using the present invention embodiment is less than 1/180th of the concentration of 1233zd(Z) in the control for the 14-day test. Similarly advantageous and unexpected results are achieved for the other test protocols and with the other compounds of this example.

### Comparative Example 3—Refrigerant Consisting of 1233zd(E) in Sealed Glass Tubes in Presence of Metal Coupons

A refrigerant composition consisting of essentially 100 percent trans1233zd (i.e., containing essentially no cis1233zd and no lubricant) was tested under the procedures in accordance with ASHRAE Standard 97—“Sealed Glass Tube Method to Test the Chemical Stability of Materials for Use within Refrigerant Systems” to simulate long-term stability of the refrigerant compositions by accelerated aging in the presence of three (3) different stainless steel coupons, namely, SS 1.4313 (Cr—Ni—Fe alloy stainless steel), SS 1.7225 (Cr—Mo—Fe alloy stainless steel) and SS 1.0577 (non-alloy stainless steel) for 14 days at 180° C. The result of this test is shown in Table CE3 below:

TABLE CE3

| | |
|---|---|
| 1233zd(Z), wt %/(ppm) | 1233zd(E), wt % |

SS 1.4313

| | |
|---|---|
| 2.0846/(20846) | 97.7049 |

SS 1.7225

| | |
|---|---|
| 2.9418/(29418) | 96.8199 |

SS 1.7225

| | |
|---|---|
| 1.8416/(18416) | 97.9417 |

As can be seen from the results above in Table CE3, substantial isomerization occurs for each of the three types of steel under these test conditions.

### Examples 3A—3C Refrigerant Consisting of 1233zd(E) in Sealed Glass Tubes in Presence of Metal Coupons and Each of d-Limonene, Farnesene and β-Pinene

Comparative Example 3 is repeated, except using 5000 ppm of an inhibiting compound of the present invention. The result of this test in terms of 1233zd(Z) content visual observations of the appearance of the sealed glass container at the end of the test is shown in Table E3 below, together with the results from Comparative Example 3 (labeled as “Control” in Table E3 and in the following chart) for ease of comparison:

TABLE E3

| | | Additives | | | |
|---|---|---|---|---|---|
| | | | | d- | β- |
| Coupon | | Control | Farnesene | limonene | pinene |
| 1.4313 | Visual | Clear | Dark yellow | Clear | Clear |
| | 1233zd(Z), ppm | 20846 | 169 | 51 | 85 |
| 1.7225 | Visual | Clear | Light yellow | Clear | Clear |
| | 1233zd(Z), ppm | 29418 | 289 | 84 | 129 |
| 1.0577 | Visual | Clear | Light yellow | Clear | Clear |
| | 1233zd(Z), ppm | 18418 | 444 | 88 | 160 |

As can be seen from the results in the table and the chart above, the compounds of the present invention provide a dramatic and unexpected ability to reduce the unwanted isomerization of 1233zd(E) to 1233zd(Z) under these important test conditions, with d-limonene and β-pinene providing especially strong inhibition performance, including the ability to maintain a clear liquid by the end of the test.

### Examples 4—High Temperature Heat Pump with Refrigerant Comprising 1233zd(E) and 0.3%-1% d-Limonene

A high temperature heat pump (HTHP) system containing a refrigerant comprising at least about 99.5% by weight of 1233zd(E) and about 0.5 wt % of d-limonene is operated under the following operating conditions:
1. Refrigerant Condensing temperature=140° C.
2. Condenser sub-cooling=5.0° C.
3. Refrigerant Evaporating temperature=70° C.
4. Evaporator Superheat=5.0° C.
5. Isentropic Efficiency=70%
6. Volumetric Efficiency=95%

To apply the accelerated test data in Example 1A and 1C, we use the generalization supported by Arrhenius's theory that the reaction rate doubles for every 10° C. increase in temperature. According to Kujak, Steve and Sorenson, Elyse Marie, “Accelerated Life Methods for Understanding Refrigerant Chemical Stability in HVACR Systems” (2018). International Refrigeration and Air Conditioning Conference. Paper 1901, the refrigerant is exposed to high temperatures in the condenser, and the compressor discharge piping for 60% of its lifetime in the equipment. Using the above information, accelerated testing for 6 weeks at 200° C. is equivalent to more than 12 years of heat pump operation. The analysis shows that the disclosed composition will be stable over the lifetime of the equipment, typically 10 years, which is a highly desirable but an expected result.

### Example 5A—High Temperature Heat Pump with Refrigerant Comprising 1233zd and d-Limonene

A high temperature heat pump (HTHP) system containing a refrigerant comprising at least about 50% by weight of 1233zd(E) and from about 0.5 wt % to about 2 wt % of d-limonene is in service for at least about 1 year under the following nominal operating conditions:
1. Refrigerant Condensing temperature=150° C.
2. Condenser sub-cooling=5.0° C.
3. Refrigerant Evaporating temperature=80° C.
4. Evaporator Superheat=5.0° C.
5. Isentropic Efficiency=70%
6. Volumetric Efficiency=95%

After being in service for at least about 1 year, the refrigerant is tested and found to contain not greater than 1 wt % 1233zd(Z) based on the total weight of 1233zd(E) and said d-limonene in the refrigerant. For the purposes of clarity, a system that has been “in service for at least about 1 year” means that the system has been available for operation as needed by the user for a period of at least 1 year.

### Example 5B—High Temperature Heat Pump with Refrigerant Comprising 1233zd and 2,6-Diisopropyl Naphthalene

A high temperature heat pump (HTHP) system containing a refrigerant comprising at least about 50% by weight of 1233zd(E) and from about 0.5 wt % to about 2 wt % of 2,6-diisopropyl naphthalene is in service for at least about 1 year under the nominal operating conditions identified in Example 5A. After being in service for about 1 year, the refrigerant is tested and found to contain not greater than 0.01 wt % 1233zd(Z) based on the total weight of 1233zd(E) and said 2,6-diisopropyl naphthalene in the refrigerant.

### Example 5C—High Temperature Heat Pump with Refrigerant Comprising 1233zd and β-Pinene

A high temperature heat pump (HTHP) system containing a refrigerant comprising at least about 50% by weight of 1233zd(E) and from about 0.5 wt % to about 2 wt % of β-pinene is in service for at least about 1 year under the nominal operating conditions identified in Example 5A. After being in service for about 1 year, the refrigerant is tested and found to contain not greater than 0.01 wt % 1233zd(Z) based on the total weight of 1233zd(E) and said β-pinene in the refrigerant.

### Example 5D—High Temperature Heat Pump with Refrigerant Comprising 1233zd and Farnesene

A high temperature heat pump (HTHP) system containing a refrigerant comprising at least about 50% by weight of 1233zd(E) and from about 0.5 wt % to about 2 wt % of farnesene is operated in service for at least about 1 year under the nominal operating conditions identified in Example 5A. After being in service for about 1 year, the refrigerant is tested and found to contain not greater than 0.02 wt % 1233zd(Z) based on the total weight of 1233zd(E) and said farnesene in the refrigerant.

### Example 5D—High Temperature Heat Pump with Refrigerant Comprising 1233zd and α-Terpinine

A high temperature heat pump (HTHP) system containing a refrigerant comprising at least about 50% by weight of 1233zd(E) and from about 0.5 wt % to about 2 wt % of α-terpinine is operated in service for at least about 1 year under the nominal operating conditions identified in Example 5A. After being in service for about 1 year, the refrigerant is tested and found to contain not greater than 0.02 wt % 1233zd(Z) based on the total weight of 1233zd(E) and said α-terpinine in the refrigerant.

### Example 6A—an Organic Rankine Cycle System with Refrigerant Comprising 1233zd and d-Limonene

An organic Rankine Cycle (ORC) system containing a refrigerant comprising at least about 50% by weight of 1233zd(E) and from about 0.5 wt % to about 2 wt % of d-limonene is in service for at least about 1 year under conditions exposing said refrigerant to a temperature of at least about 110° C. during at least a portion of the cycle. After being in service for about 1 year, the refrigerant is tested and found to contain not greater than 0.01 wt % 1233zd(Z) based on the total weight of 1233zd(E) and said d-limonene in the refrigerant.

### Example 6B—an Organic Rankine Cycle System with Refrigerant Comprising 1233zd and 2,6-Diisopropyl Naphthalene

An organic Rankine Cycle (ORC) system containing a refrigerant comprising at least about 50% by weight of 1233zd(E) and from about 0.5 wt % to about 2 wt % of 2,6-diisopropyl naphthalene service for at least about 1 year under conditions exposing said refrigerant to a temperature of at least about 110° C. during at least a portion of the cycle. After being in service for about 1 year, the refrigerant is tested and found to contain not greater than 0.01 wt % 1233zd(Z) based on the total weight of 1233zd(E) and said 2,6-diisopropyl naphthalene in the refrigerant.

### Example 6C—an Organic Rankine Cycle System with Refrigerant Comprising 1233zd and β-Pinene

An organic Rankine Cycle (ORC) system containing a refrigerant comprising at least about 50% by weight of 1233zd(E) and from about 0.5 wt % to about 2 wt % of β-pinene is in service for at least about 1 year under conditions exposing said refrigerant to a temperature of at least about 110° C. during at least a portion of the cycle. After being in service for about 1 year, the refrigerant is tested and found to contain not greater than 0.01 wt % 1233zd(Z) based on the total weight of 1233zd(E) and said β-pinene in the refrigerant.

### Example 6D—an Organic Rankine Cycle System with Refrigerant Comprising 1233zd and Farnesene

An organic Rankine Cycle (ORC) system containing a refrigerant comprising at least about 50% by weight of 1233zd(E) and from about 0.5 wt % to about 2 wt % of farnesene is service for at least about 1 year under conditions exposing said refrigerant to a temperature of at least about 110° C. during at least a portion of the cycle. After being in service for about 1 year, the refrigerant is tested and found to contain not greater than 0.02 wt % 1233zd(Z) based on the total weight of 1233zd(E) and said farnesene in the refrigerant.

### Example 6E—an Organic Rankine Cycle System with Refrigerant Comprising 1233zd and α-Terpinene

An organic Rankine Cycle (ORC) system containing a refrigerant comprising at least about 50% by weight of 1233zd(E) and from about 0.5 wt % to about 2 wt % of α-terpinene is service for at least about 1 year under conditions exposing said refrigerant to a temperature of at least about 110° C. during at least a portion of the cycle. After being in service for about 1 year, the refrigerant is tested and found to contain not greater than 0.02 wt % 1233zd(Z) based on the total weight of 1233zd(E) and said α-terpinene in the refrigerant.

What is claimed is:

1. A heat transfer composition comprising:
a. a refrigerant comprising at least about 50% by weight based on all refrigerant components of trans-1-chloro-3,3,3-trifluoropropene (HFCO-1233zd(E)); and
b. at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene, farnesene, α-terpinene and combinations of two or more of these, wherein said at least one compound is present in an amount of from 0.25% to about 2% by weight based on the weight of said HFCO-1233zd(E), said HFCO-1233zd(Z) and said at least one compound.

2. The heat transfer composition of claim 1 wherein said at least one compound comprises d-limonene.

3. The heat transfer composition of claim 1 wherein said at least one compound comprises 2,6-diisopropyl naphthalene.

4. The heat transfer composition of claim 1 wherein said at least one compound comprises β-pinene.

5. The heat transfer composition of claim 1 wherein said heat transfer composition is free of lubricating oil.

6. The heat transfer composition of claim 1 wherein said heat transfer composition has been present in a heat transfer system in service for at least 1 year and wherein during operation said heat transfer composition is exposed to a temperature of at least 110° C.

7. The heat transfer composition of claim 1 wherein the amount in said refrigerant of said HFCO-1233zd(E) and said HFCO-1233zd(Z), based on the total weight of those said components, is:
(a) at least 99% by weight of said HFCO-1233zd(E); and
(b) not greater than 1% by weight of said HFCO-1233zd(Z).

8. The heat transfer composition of claim 1 wherein the amount in said refrigerant of said HFCO-1233zd(E) and said HFCO-1233zd(Z), based on the total weight of those said components, is:
(a) at least 99.5% by weight of said HFCO-1233zd(E); and
(b) not greater than 0.5% by weight of said HFCO-1233zd(Z).

9. An ORC system which has been in service for at least 1 year or a high temperature heat pump which has been in service for at least 1 year, said system comprising:
(a) an oil-free turbine and/or an oil-free compressore,
(b) an evaporator,
(c) a condenser,
(d) a pump and
(e) a substantially oil-free refrigerant circulating in said system,
wherein said refrigerant during at least a portion of said circulation is at a temperature of at least about 110° C.; and
wherein said refrigerant comprises:
a. at least about 30% by weight based on all refrigerant components of a combination of trans-1-chloro-3,3,3-trifluoropropene (HFCO-1233zd(E)), cis-1-chloro-3,3,3-trifluoropropene (HFCO-1233zd(Z)) and at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene, farnesene, α-terpinene and combinations of two or more of these;
b. wherein the amount in said refrigerant of said HFCO-1233zd(E) and said HFCO-1233zd(Z), based on the total weight of those said components, is:
i. at least 99% by weight of said HFCO-1233zd(E); and
ii. not greater than 1% by weight of said HFCO-1233zd(Z).

10. The system or pump of claim 9 wherein said at least one compound comprises d-limonene.

11. The system or pump of claim 9 wherein said at least one compound comprises 2,6-diisopropyl naphthalene.

12. The system or pump of claim 9 wherein said at least one compound comprises β-pinene.

13. The system or pump of claim 9 wherein said at least one compound comprises farnesene.

14. The system or pump of claim 9 wherein the amount in said refrigerant of said HFCO-1233zd(E) and said HFCO-1233zd(Z), based on the total weight of those said components, is:
a. at least 99.5% by weight of said HFCO-1233zd(E); and
b. not greater than 0.5% by weight of said HFCO-1233zd(Z).

15. The system or pump of claim 10 wherein the amount in said refrigerant of said HFCO-1233zd(E) and said HFCO-1233zd(Z), based on the total weight of those said components, is:
a. at least 99.8% by weight of said HFCO-1233zd(E); and
b. not greater than 0.2% by weight of said HFCO-1233zd(Z).

16. The system or pump of claim 9 wherein the amount in said refrigerant of said HFCO-1233zd(Z) is not greater than 0.1% by weight based on the total weight of said HFCO-1233zd(E) and said HFCO-1233zd(Z).

17. A heat transfer composition comprising:
a. a refrigerant comprising at least about 70% by weight based on all refrigerant components of trans-1-chloro-3,3,3-trifluoropropene (HFCO-1233zd(E)); and
b. at least one compound inhibiting isomerization of said trans-1-chloro-3,3,3-trifluoropropene (HFCO-1233zd(E)) to cis-1-chloro-3,3,3-trifluoropropene (HFCO-1233zd(Z)), said at least one compound being selected from the group consisting of d-limonene, 2,6-diisopropyl naphthalene, β-pinene, farnesene, α-terpinene and combinations of two or more of these, wherein said at least one compound is present in an amount of from 0.25% to about 2% by weight based on the weight of said HFCO-1233zd(E), said HFCO-1233zd(Z) and said at least one compound.

18. The heat transfer composition of claim 17 wherein said heat transfer composition has been present in a heat transfer system in service for at least 1 year and wherein during operation said heat transfer composition is exposed to a temperature of at least 110° C.

19. The heat transfer composition of claim 18 wherein said refrigerant during said operation is exposed to a temperature of at least about 110° C.

20. The heat transfer composition of claim 18 wherein the amount in said refrigerant of said HFCO-1233zd(E) and said HFCO-1233zd(Z), based on the total weight of those said components, is:
a. at least 99.5% by weight of said HFCO-1233zd(E); and
b. not greater than 0.5% by weight of said HFCO-1233zd(Z).
